(19) United States
(12) Patent Application Publication
(10) Pub. No.: US 2004/0244051 A1
(43) Pub. Date: Dec. 2, 2004

(54) Method and optical transport network for providingbroadcasting services

(76) Inventors: Sang-Ho Kim, Suwon-shi (KR); Jun-Ho Koh, Suwon-shi (KR); Yong-Deok Kim, Seoul (KR); Kyu-Hyung Cho, Puchon-shi (KR); Yun-Je Oh, Yongin-shi (KR)

Correspondence Address: CHA & REITER, LLC, 210 ROUTE 4 EAST STE 103, PARAMUS, NJ, 07652, US

(21) Appl. No.: 10/781,007

(22) Filed: Feb. 18, 2004

(30) Foreign Application Priority Data
Jun. 2, 2003 (KR) 2003-35270

(51) Int. Cl. H04N 7/173

(52) U.S. Cl. 725/126; 725/95; 725/118

(57) ABSTRACT

An optical transport network for providing broadcasting services is disclosed and includes: an OLT for receiving single-channel MPTSs from a plurality of broadcasting service providers, assigning VCIs to each of the single-channel MPTSs, converting into ATM cells, and continuously transmitting optical signals according to a corresponding bandwidth; an ATM cell conversion section for converting the optical signals transmitted from the OLT into an ATM format data, dividing the ATM format data into ATM cells and outputting one broadcasting channel data from each ATM cell; a switch for switching each digital broadcasting data provided from the ATM cell conversion section to each subscriber; and a control section for receiving header information in an ATM cell from the ATM cell conversion section, updating broadcasting channel information, receiving desired broadcasting channels from subscribers, and controlling the switch so that channel data outputted from the ATM cell conversion section can be corresponded to subscribers.

### CLAIM OF PRIORITY

This application claims priority to an application entitled “Method and optical transport network for providing broadcasting services,” filed in the Korean Intellectual Property Office on Jun. 2, 2003 and assigned Serial No. 2003-35270, the contents of which are hereby incorporated by reference.

### BACKGROUND OF THE INVENTION

1. Field of the Invention

The present invention relates to a broadcasting service of an optical transport network, more particularly to a broadcasting service via a ATM-based optical transport network

2. Description of the Related Art

In a traditional analog broadcasting, entire channels are transmitted to a subscriber, and in response, a subscriber selects the desired channel by means of a TV receiver or a set top box (STB). In contrast, in digital broadcasting services, entire channels are attempted to be transmitted to a subscriber but the subscriber is unable receive all the channels to choose a selection due to the limited bandwidth in the channel transmission medium. For example, each channel in a High Definition (HD) TV set requires a transmission speed of about 20M and each channel in a Standard Definition (SD) TV set requires a transmission speed of about 3˜6M. Therefore, as the number of channels necessary for the digital broadcasting services increases, the digital broadcasting services require a transport network having a speed of several hundred M to several G so that the entire channel information can be transmitted to subscribers.

Accordingly, in a digital broadcasting, entire channels are not transmitted to the subscriber's end. To address this, a gateway connecting a plurality of subscribers is provided to transmit favorite channels of the subscribers. In this method, data are transmitted to more than one cable subscriber through a hybrid fiber coaxial cable (hereinafter, referred to as HFC). Further, broadcasting data are transmitted after several broadcasting channels are formatted into a multi-channel MPTS (multiple program transport stream) so as to be suitable for a cable network. Digital signals are typically transmitted through a QAM (quadrature amplitude modulation) transmission method, which enables several broadcasting channels to be tied together. In this method, since a channel bandwidth is limited, it is difficult to provide a broadcasting as well as the Internet at the same time. However, in the case of utilizing an optical transmission, it has no limitation in the bandwidth.

In the existing HFC network, which employs broadcasting data suitable for a cable network, the broadcasting that employs 64 QAM is transmitted in a unit of 27 Mbps tied together by means of light. Accordingly, for connection to an ADSL or a VDSL, an additional access device is necessary.

FIG. 1 is a block diagram showing the construction of a conventional optical transport network for providing digital broadcasting services. As shown, the conventional optical transport network includes an optical line terminal (hereinafter, referred to as OLT) 11 for converting digital broadcasting data received from broadcasters into optical signals, an optical network unit (hereinafter, referred to as ONU) 12, which is a user-side apparatus, for transmitting information received from the OLT 11 to a subscriber 13, and an optical fiber for connecting the OLT 11 to the ONU 12.

Particularly, the ONU 12 includes a SDH (Synchronous Digital Hierarchy) to ATM processing section 103 for converting optical signals, which contains digital broadcasting data, received from the OLT 11 into electrical signals in an ATM format, an ATM cell conversion section 104 for dividing the digital broadcasting data, which have been converted into the ATM format, into each ATM cell, a broadcasting channel conversion section 105 for dividing each channel of the ATM cell. The 0NU 12 further includes a broadcasting channel information processing section 101 for receiving and processing broadcasting channel information from the OLT 11, a control section 102 for controlling each component, and a switch 106 for switching the digital broadcasting data divided according to channel so as to be connected to each subscriber.

In operation, several broadcasting service providers transmit digital broadcasting data to the OLT 11 through each virtual channel connection (hereinafter, referred to as VCI). Herein, the VCI implies a communication path of a corresponding ATM cell.

The OLT 11 converts each digital broadcasting data into a SDH-based optical transmission format and transmits a single optical signal, and the ONU 12 receives this optical signal. Then, the SDH to ATM processing section 103 in the ONU 12 converts the digital broadcasting data transmitted in a SDH format into an ATM format. The digital broadcasting data converted into the ATM format are divided into each ATM cell through the ATM cell conversion section 104. The broadcasting channel conversion section 105 divides each channel from ATM cell and provides the switch 106 with digital broadcasting data according to channel.

Meanwhile, digital broadcasting data according to each channel are inputted to the switch 106 and switched in such a way so as to be corresponded to the subscriber 13 according to the requirement of the subscriber 13. Herein, broadcasting channel information regarding a corresponding digital broadcasting is not included in the digital broadcasting data divided into the ATM cell. In order to process such broadcasting channel information, the broadcasting channel information processing section 101 is further included.

Note that the broadcasting channel information is transmitted from the OLT 11 through a separate line. The broadcasting channel information transmitted to the broadcasting channel information processing section 101 includes broadcasting station information, etc., corresponding to a PID (program ID) included in digital broadcasting information. Channels which have been randomly added, modified, and deleted by the OLT 11 or a broadcasting service provider can be updated.

FIG. 2 is a view showing a structure of a multi-channel MPTS transceived in a conventional optical transport network. As shown, a plurality of channels are multiplexed into MPTSs and the multiplexed MPTSs are transmitted to the ONU. MPTSs 20 to 24 include a header and at least one channel data. For instance, a MPTS 20 includes data in channel 1 and channel 2, and a MPTS 21 includes data in channel 3 and channel 5. Each header of the MPTSs includes a PID, and each payload of the MPTSs includes MPEG data. Each channel transmits a plurality of services such as broadcasting services and text services.

However, such VCI frame structure is efficient, for instance, in a cable network, but entire bandwidth can't be used since the broadcasting channels are multiplexed into data in a predetermined format. That is, as shown in FIG. 2, since the multi-channel MPTSs are transmitted, a bandwidth assigned to each channel is not completely filled when channel data are transmitted. In addition, since an additional channel data for control in addition to the broadcasting data are necessary in order to tie several broadcasting channels with the multi-channel MPTSs, a more bandwidth is needed for transmitting digital broadcasting data.

Further, since digital broadcasting signals are typically modulated to form the multi-channel MPTSs according to a QAM (quadrature amplitude modulation) method, the digital broadcasting signals must be transmitted from a data link layer, which is a secondary layer, to a network layer, which is a third layer, and then processed again. Accordingly, the transmission of optical baseband signals complex. Further, in the event that the digital broadcasting signals are processed when connected to other communication networks, such as an asymmetric digital subscriber line (ADSL) network or a very high data digital subscriber line (VDSL) network that has a different data format standard, the multi-channel MPTSs must be split into each channel. As a result, the compatibility with other communication networks deteriorates.

### SUMMARY OF THE INVENTION

Accordingly, the present invention has been made to solve the above-mentioned problems and provides additional advantages, by providing a method and a digital broadcasting system for providing digital broadcasting services suitable for an optical transmission and capable of enabling digital broadcasting services transmitted by means of light to be directly connected to other communication networks.

In one embodiment, an optical transport network for providing broadcasting services is provided and includes: an OLT for receiving single-channel MPTSs from a plurality of broadcasting service providers, for assigning VCIs to each of the single-channel MPTSs, for converting into ATM cells, and for continuously transmitting optical signals according to a corresponding bandwidth; an ATM cell conversion section for converting the optical signals transmitted from the OLT into an ATM format data, dividing the ATM format data into ATM cells and outputting one broadcasting channel data from each ATM cell; a switch for switching each digital broadcasting data provided from the ATM cell conversion section to each subscriber; and a control section for receiving header information in an ATM cell from the ATM cell conversion section, for updating broadcasting channel information, for receiving desired broadcasting channels from subscribers, and for controlling the switch so that channel data outputted from the ATM cell conversion section can be corresponded to subscribers.

In another embodiment, a method for providing broadcasting services in an optical transport network is provided and includes the steps of: (1) receiving single-channel MPTSs from a plurality of broadcasting service providers, assigning each VCI to the single-channel MPTSs, converting into ATM cells and transmitting optical signals; (2) converting the transmitted optical signals into an ATM format data in a receiving side, dividing the ATM format data into ATM cells according to the VCIs, and outputting one broadcasting channel data from each ATM cell; (3) updating broadcasting channel information according to the header information in the ATM cell; and (4) receiving desired broadcasting channels from subscribers, switching each broadcasting channel data to each subscriber, and providing broadcasting services.

### BRIEF DESCRIPTION OF THE DRAWINGS

The above features and advantages of the present invention will be more apparent from the following detailed description taken in conjunction with the accompanying drawings, in which:

FIG. 1 is a block diagram showing a conventional optical transport network for providing digital broadcasting services;

FIG. 2 is a view showing a structure of a conventional multi-channel MPTS transceived in an optical transport network;

FIG. 3 is a block diagram showing a construction of an embodiment of an optical transport network including a digital broadcasting channel switching apparatus according to the present invention;

FIG. 4 is a view showing a structure of a single-channel MPTS and a VCI frame structure thereof transceived in an optical transport network according to an embodiment of the present invention; and

FIG. 5 is a flowchart illustrating a method for processing digital broadcasting data in an ONU according to the present invention.

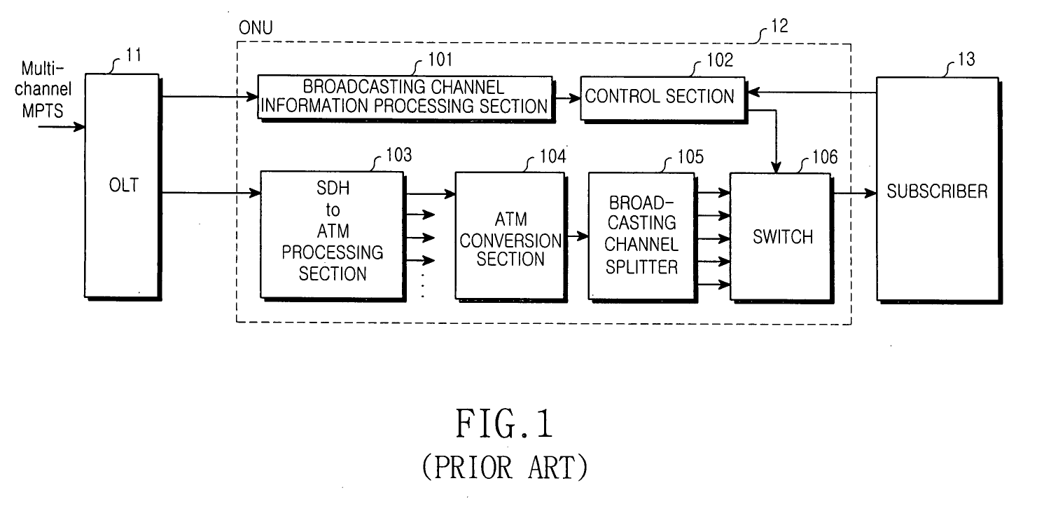

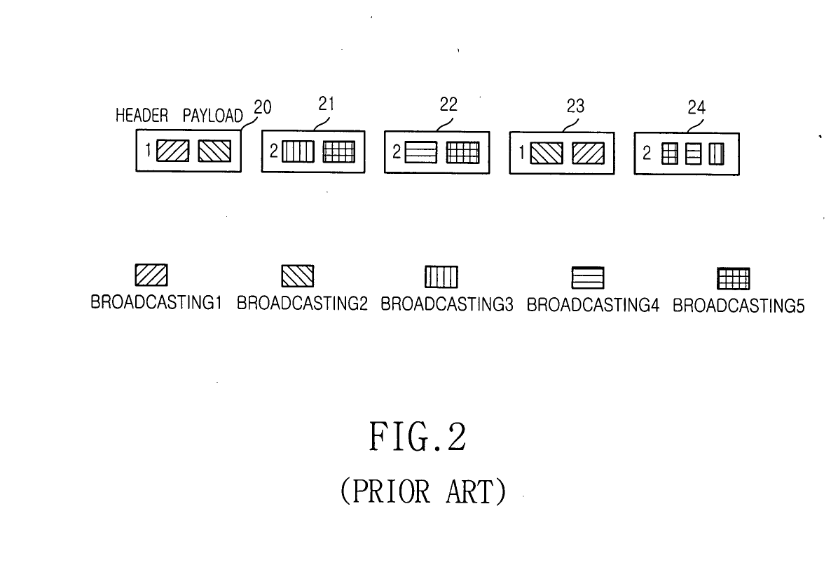

### DETAILED DESCRIPTION OF THE PREFERRED EMBODIMENT

Hereinafter, a preferred embodiment according to the present invention will be described with reference to the accompanying drawings. For the purposes of clarity and simplicity, a detailed description of known functions and configurations incorporated herein will be omitted as it may make the subject matter of the present invention unclear.

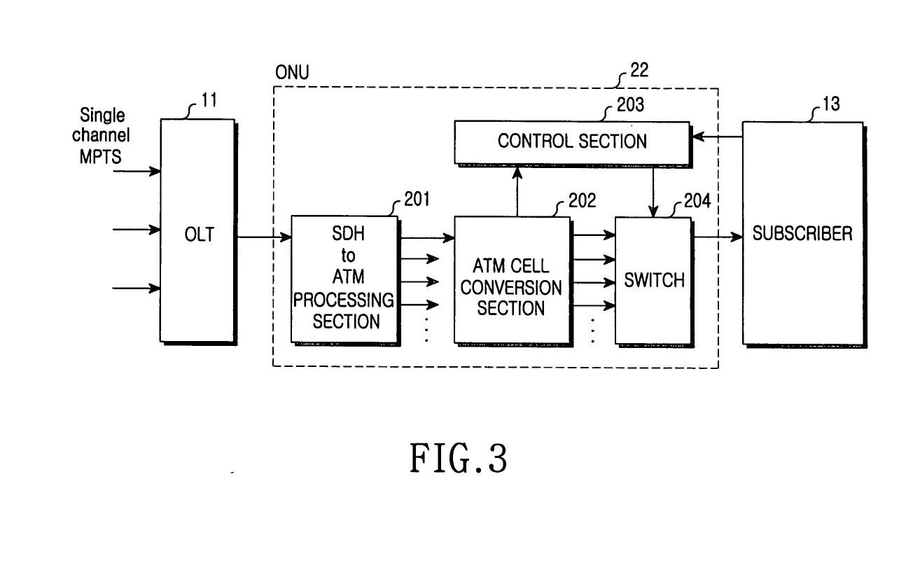

FIG. 3 is a block diagram showing the construction an optical transport network including a digital broadcasting channel switching apparatus according to the embodiment of the present invention.

As shown in FIG. 3, the optical transport network for providing digital broadcasting services to a subscriber 13 according to the present invention includes an OLT (optical line terminal) 11 for converting digital broadcasting data transmitted from broadcasting service providers into optical signals for subsequent transmission to at least one ONU (optical network unit) 22, which is a user-end device for transmitting information received from the OLT 11 to the subscriber 13. An optical fiber is provided between the OLT 11 to the ONU 22 for transmission.

The ONU 22 includes a SDH (Synchronous Digital Hierarchy), an ATM processing section 201 for converting optical signals of the digital broadcasting data received from the OLT 11 into electrical signals in an ATM format, an ATM cell conversion section 202 for dividing the digital broadcasting data into each ATM cell, a switch 204 for switching each digital broadcasting data provided from the ATM cell conversion section 202 so as to be connected to the channel desired by each subscriber, and a control section 203 for controlling each component.

As artesian can appreciate, a plurality of broadcasting service providers can format MPEG2-TSs, which are digital broadcasting data, according to a digital video signal standard for an ASI (a synchronous serial interface). The formatted ASI data may include a plural of simultaneous broadcasting programs.

The digital broadcasting data formatted, as described above, becomes single-channel MPTSs (multiple program transport streams). The broadcasting service providers transmit multi-channel MPTSs having a plurality of single-channel MPTSs tied together by means of the QAM (quadrature amplitude modulation) method, through an optical transport network. Note that most cable networks or existing digital TV networks are currently capable of transmitting the single-channel MPTSs.

Accordingly, a plurality of single-channel MPTSs are received by the OLT 11, and when each digital broadcasting data is received in the ASI format, the OLT 11 finds a start of the digital broadcasting data by means of a sync byte of the MPEG2-TS which are digital broadcasting data, and then filters the PID (program ID) information of the digital broadcasting channel. At the same time, the OLT 11 converts each MPEG2-TS in a plurality of single-channel MPTSs into ATM cells and assigns an individual VCI to each of the ATM cells. For instance, each channel provided by a particular Broadcasting System will have one assigned VCI.

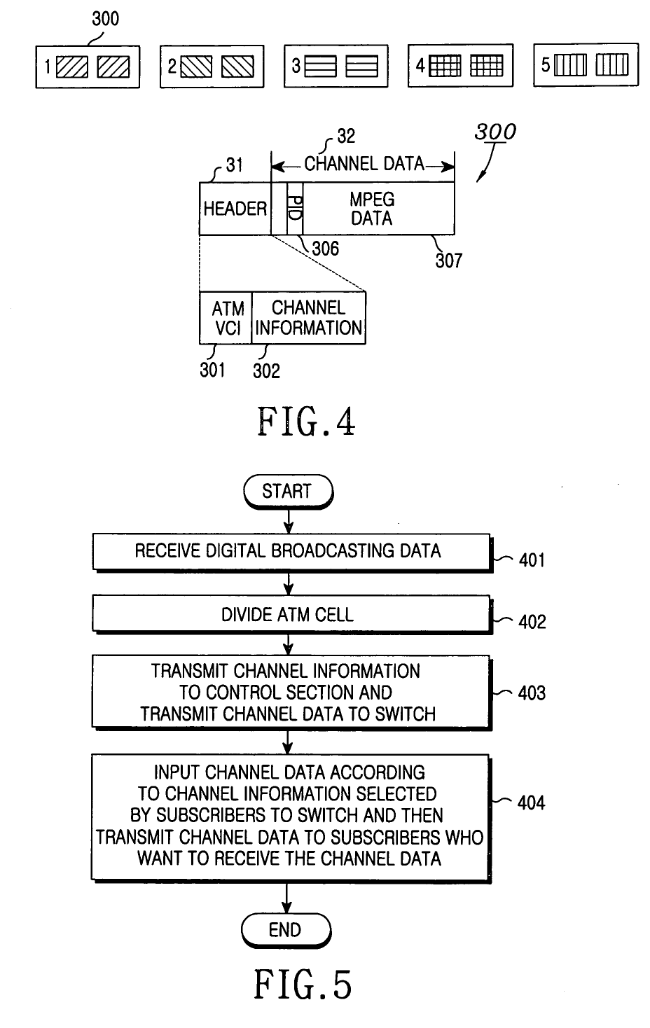

FIG. 4 is a view showing the structure of a single-channel MPTS and a VCI frame structure thereof transceived in an optical transport network according to an embodiment of the present invention. In the optical transport network according to the present invention, the network forms data with regard to one channel into a single-channel MPTS as shown in an upper portion of FIG. 4 and transmits the MPTS to the OLT 11. The single-channel MPTS 300 includes a header and one channel data.

In particular, a VCI frame (shown in a lower portion of FIG. 4) of the single-channel MPTS 300 according to the present invention includes a header field 31 and a payload portion containing one channel field 32 with digital broadcasting data. Particularly, the header field 31 includes an ATM VCI field, which implies that this frame is an ATM VCI, and a channel information field containing broadcasting station information, etc., corresponding to the PID information in the channel field 32. The broadcasting channel field 32 includes a MPEG data field 307, which are digital broadcasting data, and a PID information field 306 containing channel information.

The VCI frame constructed as shown in FIG. 4 is converted into SDH optical signals by the OLT 11 and the converted optical signals are transmitted to the ONU 22 through an optical line. The ONU 22 converts digital broadcasting data, which have been converted into the SDH format, into an ATM format. The digital broadcasting data having been converted into the ATM format are divided by the ATM cell conversion section 202 into each ATM cell. Thereafter, the ATM cell conversion section 202 transmits the information in the channel information field 302 included in the header in the VCI frame to the control section 203. The control section 203 has variable channel information and use it to control the switching of channel desired by a subscriber.

The control section 203 receives the information in the channel information field 302 included in the header in the VCI frame from the ATM cell conversion section 202 and automatically controls the switching of broadcasting channel desired by the subscriber. Further, the control section 203 receives information regarding desired broadcasting channels from subscribers and controls the switch 204 so that digital broadcasting data in corresponding broadcasting channels can be provided to the subscribers. To this ends, the switch 204 switches the digital broadcasting data outputted from the control section 203 so as to be corresponded to the subscriber 13, who wishes to receive the broadcasting data, according to the control of the control section 203.

FIG. 5 is a flowchart illustrating a method for processing digital broadcasting data in an ONU according to the present invention.

Initially, in step 401, the ONU 22 receives broadcasting data converted into a SDH format from the OLT 11. In step 402, the ONU 22 converts the received broadcasting data into an ATM format and divides the converted ATM cells according to VCIs. In the present invention, one VCI is assigned to one channel data. In step 403, the ATM cell conversion section 202 of the ONU 22 provides the broadcasting channel information to the control section 203 and the broadcasting channel data to the switch 204. Here, the VCI is divided into a broadcasting channel and a control VCI. The control VCI indicates the relationship between a channel of broadcasting data and the VCI.

Finally, in step 404, the control section 203 of ONU 22 receives the desired broadcasting channel information requested by the subscribers and matches the V CIs of desired broadcasting channels from the broadcasting channel information updated in step 403. Then, the control section 203 of ONU transmits only broadcasting channel data, which correspond to broadcasting channel information desired by the subscribers from among PID information extracted on the basis of the information regarding broadcasting channels desired by subscribers, to the switch 204, thereby enabling each subscriber to receive channel data which the subscriber wishes to receive.

According to the present invention, as described above, since each VCI is assigned to each broadcasting data, each broadcasting channel can be divided in the ONU 22 according to the VCI when the broadcasting data are converted into ATM cells. Therefore, the broadcasting data can be read rapidly and easily during operation. Moreover, since the broadcasting channel data divided according to the VCI are signals in a secondary layer, which have not been modulated as the prior art, the broadcasting channel data can be easily connected to other communication networks. That is, since each broadcasting channel data is transmitted as individual data without following a cable network standard, the broadcasting channel data can be easily connected to communication networks of various types.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical transport network for providing broadcasting services, comprising:
an OLT for assigning VCIs to each of single-channel MPTSs received from a plurality of broadcasting service providers and converting the single-channel MPTSs into a plurality of ATM cells;
an ATM cell conversion section for converting the output signals from the OLT into an ATM format and for outputting at least one broadcasting channel data from each ATM cell;
a switch for switching each digital broadcasting data output from the ATM cell conversion section to a subscriber; and
a control section for receiving the header information in the ATM cell from the ATM cell conversion section, for receiving a desired broadcasting channel from the subscriber, and for controlling the switch so that channel data outputted from the ATM cell conversion section can be corresponded to the channel desired by the subscriber.

2. The optical transport network as claimed in claim 1, wherein the header information includes an ATM VCI field representing a communication path of a corresponding ATM cell, and a channel information field containing broadcasting station information corresponding to PID information of each broadcasting channel field included in a payload portion of the ATM cell.

3. A method for providing broadcasting services in an optical transport network, the method comprising the steps of:
(1) receiving single-channel MPTSs from a plurality of broadcasting service providers, assigning each VCI to the single-channel MPTSs, converting the single-channel MPTSs into ATM cells;
(2) converting the converted single-channel MPTSs into an ATM format data, dividing the ATM format data into ATM cells according to the VCIs, and outputting at least one broadcasting channel data from each ATM cell;
(3) updating broadcasting channel information according to the header information in the ATM cell; and
(4) upon receiving a channel request from a subscriber, switching each broadcasting channel data to the requested channel by the subscriber.

4. The method as claimed in claim 3, wherein the header information includes an ATM VCI field representing a communication path of a corresponding ATM cell,and a channel information field containing broadcasting station information corresponding to PID information of each broadcasting channel field included in a payload portion in the ATM cell.

5. An optical transport network for providing broadcasting services comprising:
an OLT for converting digital broadcasting data from a plurality of service providers into optical signals in the form of a plurality of ATM cells and for assigning an individual VCI to each of the ATM cells;
an ONU for converting the output signals from the OLT into electrical signals according to an ATM format; and
a controller for providing a broadcasting service requested by a subscriber by matching the VCI that matches the broadcasting service requested by the subscriber.

6. The optical transport network as claimed in claim 5, wherein the digital broadcasting data from the plurality of service providers are in the form of single-channel MPTSs (multiple program transport streams).

7. The optical transport network as claimed in claim 6, wherein the single-channel MPTS comprises at least one header and at least one channel data.

8. The optical transport network as claimed in claim 7, wherein the header field includes an ATM VCI field and a channel information field with broadcasting station information.

9. The optical transport network as claimed in claim 8, wherein the broadcasting channel field includes a MPEG data field having digital broadcasting data and a PID information field having channel information.

10. The optical transport network as claimed in claim 5, wherein the output of the OLT is transmitted to the ONU via an optical fiber.
